(19) United States
(12) Patent Application Publication
(10) Pub. No.: US 2015/0123934 A1
(43) Pub. Date: May 7, 2015

(54) TOUCH SENSOR MODULE

(71) Applicant: SAMSUNG ELECTRO-MECHANICS CO., LTD., Gyeonggi-Do (KR)

(72) Inventors: Ji Soo LEE, Gyeonggi-Do (KR); Hyung Ho KIM, Gyeonggi-Do (KR); Kyoung Soo CHAE, Gyeonggi-Do (KR); Young An CHOI, Gyeonggi-Do (KR); Seung Hoon HAN, Gyeonggi-Do (KR); Yun Ki HONG, Gyeonggi-Do (KR); Gwan Ha JEONG, Gyeonggi-Do (KR)

(73) Assignee: SAMSUNG ELECTRO-MECHANICS CO., LTD., Gyeonggi-Do (KR)

(21) Appl. No.: 14/312,011

(22) Filed: Jun. 23, 2014

(30) Foreign Application Priority Data
Nov. 5, 2013 (KR) 10-2013-0133590

(51) Int. Cl. G06F 1/16; G06F 3/045; G06F 3/041; G06F 3/044

(52) U.S. Cl. CPC G06F 1/1643; G06F 3/044; G06F 3/045; G06F 3/0412
USPC 345/174

(57) ABSTRACT

Embodiments of the invention provide a touch sensor module, which includes a flexible cable having one or more terminal parts, and an adhesive layer contacting one surface of the terminal parts to transfer electrical signals. The touch sensor module further includes a base substrate including electrode pads formed to correspond to the terminal parts and contacting the other surface of the adhesive layer, and protecting layers formed along edges of the electrode pads.

### CROSS REFERENCE TO RELATED APPLICATION

This application claims the benefit of and priority under 35 U.S.C. §119 to Korean Patent Application No. KR 10-2013-0133590, entitled “TOUCH SENSOR MODULE,” filed on Nov. 5, 2013, which is hereby incorporated by reference in its entirety into this application.

### BACKGROUND

1. Field of the Invention

The present invention relates to a touch sensor module.

2. Description of the Related Art

In accordance with the growth of computers using a digital technology, devices assisting computers have also been developed, and personal computers, portable transmitters, other personal information processors execute processing of text and graphics using various input devices such as a keyboard and a mouse.

In accordance with the rapid advancement of an information-oriented society, the use of computers has gradually increased. However, it is difficult to efficiently operate products using only a keyboard and a mouse currently serving as an input device. Therefore, the necessity for a device that is simple, experiences less malfunctions, and is capable of easily inputting information has increased.

Techniques for input devices have progressed toward techniques related to high reliability, durability, innovation, designing and processing beyond a level of satisfying general functions. To this end, a touch sensor has been developed as an input device capable of inputting information, such as text and graphics, as non-limiting examples.

The conventional touch sensor is mounted on a display surface of a display, such as an electronic organizer, a flat panel display device including a liquid crystal display (LCD) device, a plasma display panel (PDP), an electroluminescence (EI) element, and a cathode ray tube (CRT) to thereby be used to allow a user to select desired information while viewing the display.

The touch sensor is classified, for example, into a resistive type touch sensor, a capacitive type touch sensor, an electromagnetic type touch sensor, a surface acoustic wave (SAW) type touch sensor, and an infrared type touch sensor.

These various types of touch sensors are adapted for electronic products in consideration of a signal amplification problem, a resolution difference, a level of difficulty of designing and processing technologies, optical characteristics, electrical characteristics, mechanical characteristics, environment resistance, input characteristics, durability, and economic efficiency. Currently, the resistive type touch sensor and the capacitive type touch sensor have been prominently used in a wide range of fields.

Korean Patent Application No. KR 10-2011-0107590 describes an example of a conventional touch sensor. The touch sensor is configured to include a substrate, electrodes formed on the substrate, electrode wirings extended from the electrodes and gathered on one end of the substrate, and a controller connected to the electrode wirings through a flexible printed circuit board (hereinafter, referred to as a “flexible cable”).

The flexible cable serves to transfer signals generated in the electrode to the controlling unit through the electrode wirings. In addition, the flexible cable electrically contacts and is connected to the electrode wiring in order to transfer a signal. However, a connection defect between the flexible cable and the electrode wiring is frequently generated due to permeation of moisture, and reliability of a product is decreased due to the frequent connection defect.

### SUMMARY

Accordingly, embodiments of the invention have been made to solve the above-mentioned problems, and therefore provide a touch sensor module capable of preventing disconnection and a contact defect between an electrode pad and a flexible cable due to moisture by including a protecting layer formed on an outer peripheral surface of the electrode pad.

According to a first embodiment of the invention, there is provided a touch sensor module including a flexible cable having one or more terminal parts, an adhesive layer contacting one surface of the terminal parts to transfer electrical signals, a base substrate including electrode pads formed to correspond to the terminal parts and contacting the other surface of the adhesive layer; and protecting layers formed along edges of the electrode pads.

According to an embodiment, the adhesive layer is made of an anisotropic conductive film (ACF) or an anisotropic conductive adhesive (ACA).

According to an embodiment, the protecting layer is formed along the edge of the electrode pad to be spaced apart from the edge of the electrode pad by a distance larger than a diameter of a conductive ball made of an ACF or an ACA, thereby preventing a short circuit.

According to an embodiment, the protecting layer is made of the same material as that of the electrode pad or be made of a porous material denser than a material of the electrode pad in order to prevent corrosion of the electrode pad.

According to an embodiment, the protecting layers is formed along the respective edges of one or more electrode pads.

According to an embodiment, the protecting layers are formed in each region of one or more electrode pads.

According to a second embodiment of the invention, there is provided a touch sensor module including a base substrate including one or more electrode pads transferring electrical signals of electrode patterns to the outside and first protecting layers formed along outer peripheral surfaces of the electrode pads, an adhesive layer contacting one surface of the electrode pads to transfer the electrical signals, and a flexible cable including terminal parts contacting the other surface of the adhesive layer and formed to correspond to the electrode pads and second protecting layers formed along outer peripheral surfaces of the terminal parts.

According to an embodiment, the adhesive layer is made of an ACF or an ACA.

According to an embodiment, the first protecting layer and the second protecting layer are formed along edges of the electrode pad and the terminal part, respectively, to be spaced apart from the edges of the electrode pad and the terminal part by a distance larger than a diameter of a conductive ball made of an ACF or an ACA, respectively, thereby preventing a short circuit.

According to an embodiment, the first protecting layer and the second protecting layer are made of the same materials as those of the electrode pad and the terminal part, respectively, or made of porous materials denser than materials of the electrode pad and the terminal part, respectively, in order to prevent corrosion of the electrode pad and the terminal part, respectively.

According to an embodiment, the first protecting layers and the second protecting layers are formed along the respective edges of one or more electrode pads and the terminal parts, respectively.

According to an embodiment, the first protecting layers and the second protecting layers are formed along edges in each region of one or more electrode pads and the terminal parts, respectively.

According to a third embodiment of the invention, there is provided a touch sensor module including a base substrate including one or more electrode pads transferring electrical signals of electrode patterns to the outside, an adhesive layer contacting one surface of the electrode pads to transfer the electrical signals, a base substrate including terminal parts formed to correspond to the electrode pads and contacting the other surface of the adhesive layer; and protecting layers formed along edges of the terminal parts.

According to an embodiment, the adhesive layer is made of an ACF or an ACA.

According to an embodiment, the protecting layer is formed along the edge of the electrode pad to be spaced apart from the edge of the electrode pad by a distance larger than a diameter of a conductive ball made of an ACF or an ACA, thereby preventing a short circuit.

According to an embodiment, the protecting layer is made of the same material as that of the terminal part or be made of a porous material denser than a material of the terminal part in order to prevent corrosion of the terminal part.

According to an embodiment, the protecting layers are formed along the respective edges of one or more terminal parts.

According to an embodiment, the protecting layers are formed in each region of one or more terminal parts.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a view showing a portion of a base substrate of a touch sensor module according to a first embodiment of the invention.

FIG. 2 is a top assembled cross-sectional view of the base substrate and a flexible cable taken along line A-A of FIG. 1 according to an embodiment of the invention.

FIG. 3 is a bottom assembled cross-sectional view of the base substrate and a flexible cable taken along line B-B of FIG. 1 according to an embodiment of the invention.

FIG. 4 is an enlarged view of part C for a protecting layer of the base substrate of FIG. 1 according to an embodiment of the invention.

FIG. 5 is a view showing a modified example of the protecting layer of the base substrate of FIG. 4 according to an embodiment of the invention.

FIG. 6 is a plan view of the flexible cable according to the first embodiment of the invention.

FIG. 7 is an assembled cross-sectional view of a base substrate and a flexible cable according to a second embodiment of the invention.

FIG. 8 is a plan view of an electrode pattern of FIG. 7 according to an embodiment of the invention.

FIG. 9 is an assembled cross-sectional view of a base substrate and a flexible cable according to a third embodiment of the invention.

FIG. 10 is an assembled cross-sectional view of a base substrate and a flexible cable according to a fourth embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, preferred embodiments of the present invention will be described in detail with reference to the accompanying drawings.

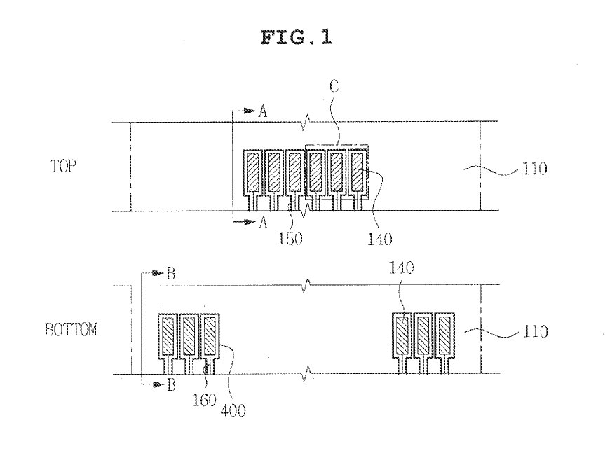

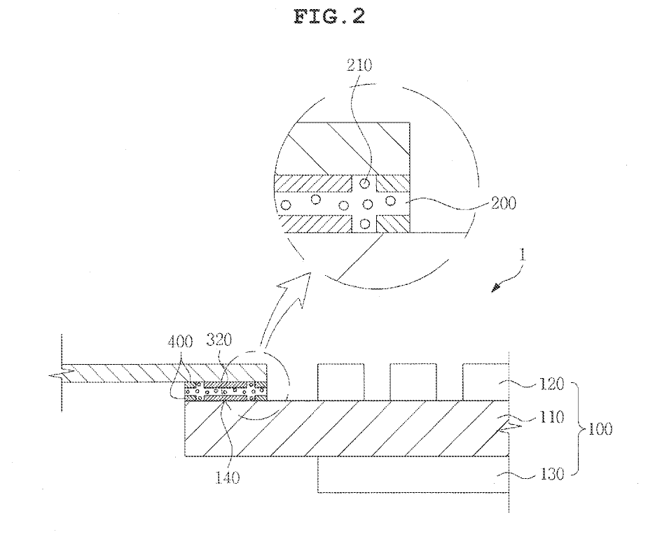

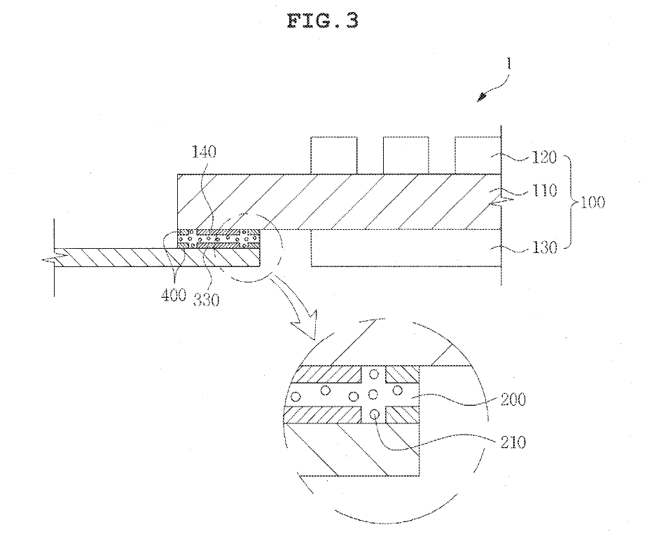

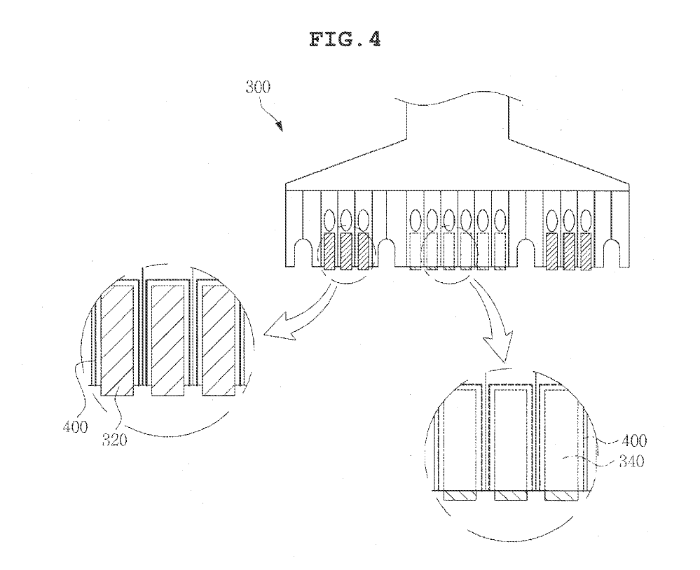

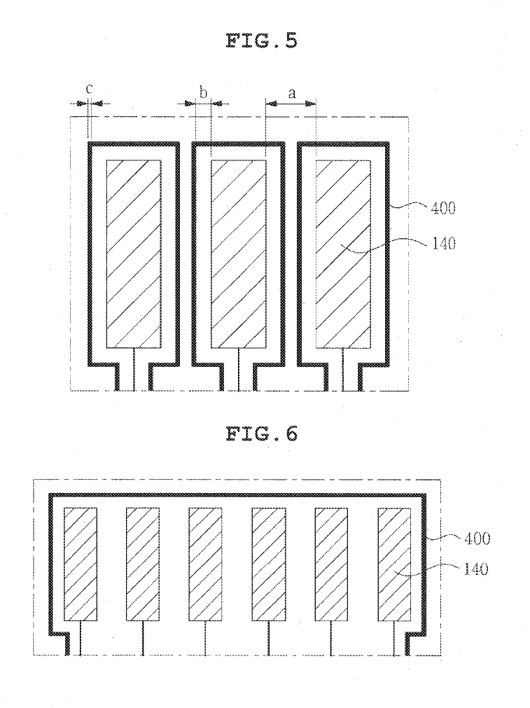

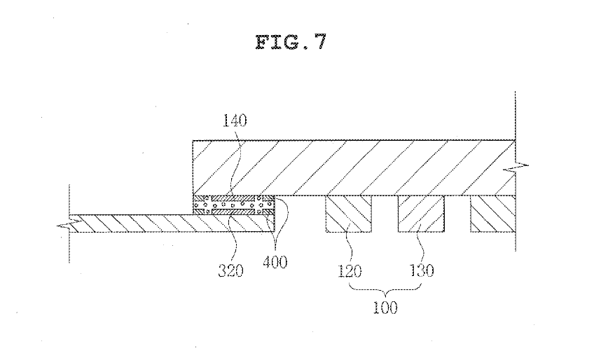

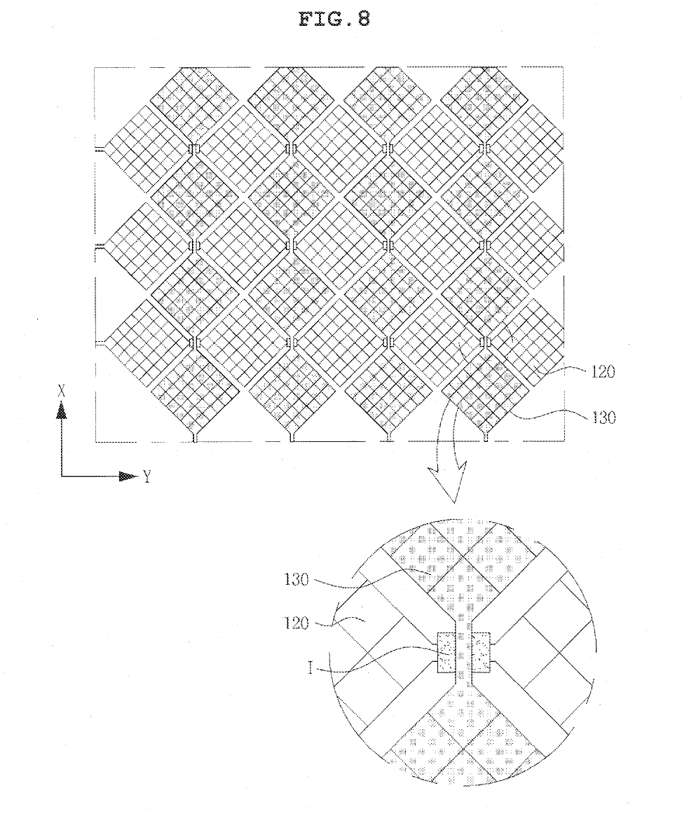

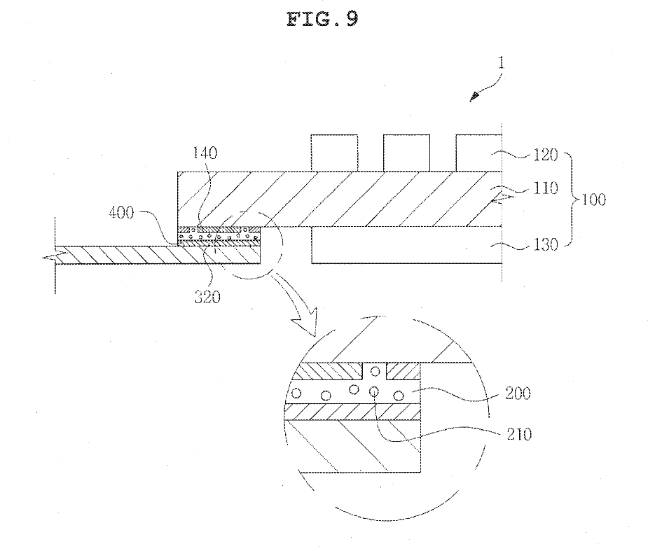

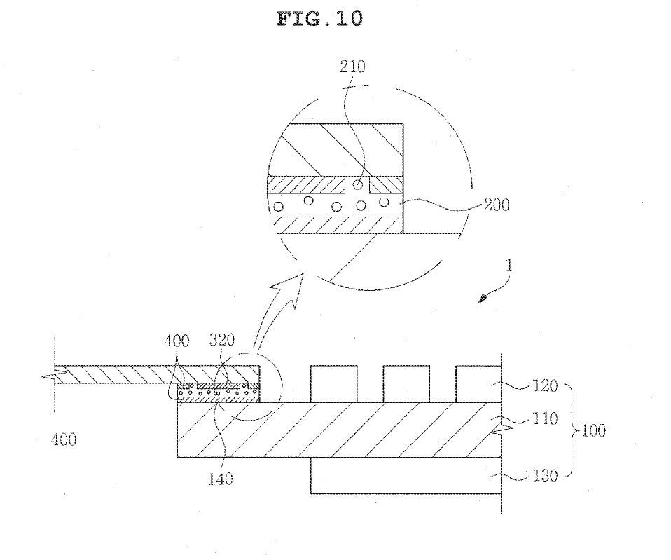

FIG. 1 is a view showing a portion of a base substrate of a touch sensor module according to a first embodiment of the invention; FIG. 2 is a top assembled cross-sectional view of the base substrate and a flexible cable taken along line A-A of FIG. 1 according to an embodiment of the invention; FIG. 3 is a bottom assembled cross-sectional view of the base substrate and a flexible cable taken along line B-B of FIG. 1 according to an embodiment of the invention; FIG. 4 is an enlarged view of part C for a protecting layer of the base substrate of FIG. 1 according to an embodiment of the invention; FIG. 5 is a view showing a modified example of the protecting layer of the base substrate of FIG. 4 according to an embodiment of the invention; FIG. 6 is a plan view of the flexible cable according to the first embodiment of the invention; FIG. 7 is an assembled cross-sectional view of a base substrate and a flexible cable according to a second embodiment of the invention; FIG. 8 is a plan view of an electrode pattern of FIG. 7 according to an embodiment of the invention; FIG. 9 is an assembled cross-sectional view of a base substrate and a flexible cable according to a third embodiment of the invention; and FIG. 10 is an assembled cross-sectional view of a base substrate and a flexible cable according to a fourth embodiment of the invention.

A term ‘touch’ used throughout the present specification should be widely interpreted to mean that an input unit becomes significantly close to a contact accommodating surface as well as mean that the input unit directly contacts the contact accommodating surface.

A touch sensor module 1 according to a first embodiment of the invention is configured to include a flexible cable 300 having one or more terminal parts 320 and 330, an adhesive layer 200 contacting one surface of the terminal parts 320 and 330 to transfer electrical signals, a base substrate 110 including electrode pads 140 formed to correspond to the terminal parts 320 and 330 and contacting the other surface of the adhesive layer 200, and protecting layers 400 formed along edges of the electrode pads 140 and the terminal parts 320 and 330.

Embodiments of the invention improve characteristics, such as moisture resistance and environment resistance of the touch sensor module 1 and to minimize permeation of moisture, for example, into the touch sensor module 1. Therefore, reliability of an operation of the touch sensor module is maintained even in a hot and humid environment, such that convenience of a user is increased and an applicable field of the touch sensor module 1 is diversified.

In an embodiment of the invention, various touch sensors 100, for example, a resistive type touch sensor and a capacitive type touch sensor is used as a touch sensor 100. However, a form and a kind of touch sensor 100 are not particularly limited. However, in the touch sensor module 1 according to the first embodiment of the invention, a capacitive type touch sensor 100 having electrode patterns 120 and 130 formed on both surfaces of a transparent substrate 110 will be described by way of example.

Referring to FIG. 1, the base substrate 110 serves to provide a region in which the electrode patterns 120 and 130 and electrode wirings 150 and 160 are to be formed. The base substrate 110 is divided into an active region and a bezel region, wherein the active region, which is a portion provided with the electrode patterns 120 and 130 to recognize a touch of an input unit, is formed at the center of the base substrate 110 and the bezel region, which is a portion provided with the electrode wirings 150 and 160 extended from the electrode patterns 120 and 130, is formed at an edge of the active region. The base substrate 110 should have support force capable of supporting the electrode patterns 120 and 130 and the electrode wirings 150 and 160 and transparency capable of allowing a user to recognize an image provided by an image display device (not shown). In consideration of the support force and the transparency, the base substrate 110, according to an embodiment of the invention, is made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass, as non-limiting examples, and therefore is not necessarily limited thereto.

Referring to FIGS. 1 to 4, the electrode patterns 120 and 130, which serve to generate a signal at the time of being touched by an input unit to allow a controller to recognize a touch coordinate, are formed on the base substrate 110. According to an embodiment of the invention, an electrode pattern formed in an X axis direction of the base substrate 110 will be referred to as a first electrode pattern 120, and an electrode pattern formed in a Y axis direction of the base substrate 110 will be referred to as a second electrode pattern 130.

According to an embodiment, the electrode patterns 120 and 130 are formed, for example, by a plating process or a depositing process using a sputter. The electrode pattern 120 and 130 is made, for example, of a metal formed by exposing/developing a silver salt emulsion layer. More specifically, it is obvious to those skilled in the art that the electrode patterns 120 and 130 are made of various kinds of metals that have conductivity and are capable of forming mesh patterns. The electrode patterns 120 and 130 are formed in all shapes known in the art, such as a diamond shape, a rectangular shape, a triangular shape, a circular shape, as non-limiting examples.

Bar patterns perpendicular to bar patterns in one direction are formed as the electrode patterns 120 and 130 on the base substrate 110. The electrode patterns 120 and 130 are formed on both surfaces of the base substrate 110, such that the touch sensor is touched and driven in a mutual type. Alternatively, patterns having a diamond shape are arranged using a bridge made of an insulating material on one surface of the base substrate 110 to be perpendicular to each other to form the electrode patterns 120 on a single base substrate 110, thereby making it possible to implement the touch sensor module 1.

The electrode wirings 150 and 160 are electrically connected to the electrode patterns 120 and 130 described above through the flexible cable 300. The electrode wirings 150 and 160, according to an embodiment of the invention, are formed on the base substrate 110 by various printing methods, such as a silk screen method, a gravure printing method, an inkjet printing method, as non-limiting examples (see FIG. 3). The material of the electrode wirings 150 and 160 includes, for example, copper (Cu), aluminum (Al), gold (Au), silver (Ag), titanium (Ti), palladium (Pd), or chromium (Cr). The electrode wirings 150 and 160 are made of silver (Ag) paste or organic silver having excellent electrical conductivity. However, the electrode wirings are not limited to being made of the above-mentioned material, but may be made of a conductive polymer, carbon black (including CNT), a metal oxide such as ITO, or a low resistance metal material, as non-limiting examples.

The electrode wiring 160 is connected to only one end of the electrode pattern 120 depending on a scheme of the touch sensor module 1. The electrode wirings 150 and 160 have the electrode pads 140 disposed at distal end portions thereof, wherein the electrode pads 140 are electrically connected to the flexible cable 300. In other words, the electrode pads 140 are formed at one portion of the electrode wirings 150 and 160 and are electrically connected to the flexible cable 300.

The electrodes 140 are connected to the electrode wirings 150 and 160 and are formed on the base substrate 110 (see FIG. 1). The electrode pads 140 are formed to not invade the flexible cable 300 and the active region of the base substrate 110, i.e., a region in which a touch of the user is recognized. The electrode pads 140 are positioned at distal end portions of one side of the base substrate 110 and are connected to the electrode wirings 150 and 160. The electrode pads 140 contact the adhesive layer 200 to allow electricity to be conducted to the flexible cable 300. The electrode pads 140 are coupled to the adhesive layer 200 by pressing the flexible cable 300. In this case, the electrode pads 140 are coupled to the adhesive layer 200 in a direction in which the base substrate 110 is stacked. The electrode pads 140 have a contact surface contacting conductive balls 210 of the adhesive layer 200. The contact surface has a diameter larger than that of the conductive ball 210. A plurality of electrode pads 140 are disposed at a distal end portion of one side of the base substrate 110. Here, the electrode pads 140 are formed to be spaced apart from each other by a predetermined distance so that electrical interference between adjacent electrode pads is not generated.

Embodiments of the invention prevent permeation of moisture by forming the protecting layers on the electrode pads and the terminal parts in order to further improve characteristics, such as moisture resistance and environment resistance, of the touch sensor module 1.

According to an embodiment, the protecting layers 400 are formed along outer peripheral surfaces of the electrode pads 140 and the terminal parts 320 and 330. The protecting layer 400 is made, for example, of copper (Cu), aluminum (Al), gold (Au), silver (Ag), titanium (Ti), palladium (Pd), or chromium (Cr). The protecting layer 400 is made, for example, of silver (Ag) paste or organic silver having excellent electrical conductivity. However, the protecting layer is not limited to being made of the above-mentioned material, but may be made of a conductive polymer, carbon black (including CNT), a metal oxide such as ITO, or a low resistance metal materials, as non-limiting examples. This is not to limit a material of the protecting layer 400. The protecting layers 400 are made of a porous material denser than materials of the electrode pads 140 and the terminal parts 320 and 330 in order to prevent corrosion of the electrode pads 140 and the terminal parts 320 and 330. The protecting layers 400 made of the porous material suppress or prevent moisture from permeating into the electrode pads 140 and the terminal parts 320 and 330.

According to an embodiment, the protecting layers prevent the moisture from permeating into the electrode patterns 120 and 130, the electrode wirings 150 and 160, and the electrode pads 140. Thus, the protecting layers prevent permeation of moisture and sweat at the time of using the touch sensor to prevent an electrical short circuit.

According to an embodiment, the protecting layer is formed along the edge of the electrode pad 140 to be spaced apart from the edge of the electrode pad 140 by a predetermined distance. The predetermined distance should be larger than a diameter D of a conductive ball 210 to be described below. The reason is to prevent the conductive ball 210 from contacting the protecting layer 400 and the electrode pad 140 between the protecting layer 400 and the electrode pad 140 to cause a short circuit. The protecting layers 400 are formed to not electrically interfere with the electrode pads 140.

For example, a relationship between the protecting layers and the electrode pads will be described with reference to FIG. 5. When a distance between the electrode pads is A, a width of a protecting line of the protecting layer is C, a distance between the electrode pad and the protecting layer is B, a distance between the protecting layers is L, and a diameter of the conductive ball is D, the following Equations are satisfied:

1 μm<D<120 μm Equation 1)

B>D Equation 2)

L<A/2 Equation 3)

C+B<A/2 Equation 4)

0<C<A/2−B Equation 5)

Thus, it may be appreciated that the distance between the protecting layer 400 and the electrode pad 140 should be larger than the diameter of the conductive ball and the protecting layers 400 should be formed to not be short-circuited and to enclose the electrode pads 140. In addition, the above mentioned Equations are also applied to the case in which the protecting layers 400 are formed on the terminal parts 320 and 330.

In some cases, as shown in FIG. 6, the protecting layer is formed along a region of a plurality of electrode pads 140. That is, the protecting layer 400 is formed along an outer peripheral surface of the region of the plurality of electrode pads 140.

In this case, the following Equations are satisfied:

1 μm<Diameter (D) of Conductive Ball<120 μm Equation 1)

B>D Equation 2)

Thus, a space between the protecting layer 400 and the electrode pad 140 is larger than a diameter of the conductive ball.

Referring to FIGS. 3 and 4, the adhesive layer 200 contacts the electrode pad 140 and is electrically connected to the electrode pads 140. In the case in which the adhesive layer 200 is pressed to thereby be coupled or adhered, an inner portion of the adhesive layer 200 is provided with the conductive balls 210 having conductivity. The conductive balls 210 conduct electricity in one direction while being pressed to thereby be bonded in a process of coupling the electrode pad 140 and the terminal part 320 to each other. The adhesive layer 200 has a lower end surface connected to the electrode pad 140 and an upper end surface coupled and adhered to the terminal part 320. That is, the conductive ball 210 disposed in the adhesive layer 200 has one surface adhered to the electrode pad 140 and the other surface adhered to the terminal part 320. This is not to limit a form in which the adhesive layer 200 is adhered to the electrode pad 140 and the terminal part 320.

It is preferable that the adhesive layer 200 is made of an anisotropic conductive film (ACF). In some cases, the adhesive layer 200 is made of a conductive material, such as an anisotropic conductive adhesive (ACA), or the like.

Referring to FIG. 4, the flexible cable 300 is coupled to the electrode pad 140. The flexible cable 300 includes the terminal parts 320 and 330 contacting the adhesive layer 200. The flexible cable 300 is electrically connected to the electrode pad 140 to electrically connect the electrode patterns 120 and 130 and a controlling unit (not shown) to each other. The terminal parts 320 and 330 contact the conductive balls 210, such that they are electrically connected to each other. The terminal parts 320 and 330 are formed at positions corresponding to those of the plurality of electrode pads 140. The terminal parts 320 and 330 are coupled to the electrode pads 140 through the adhesive layer 200 by a resin generated by pressing. When the terminal parts 320 and 300 and the electrode pads 140 are easily coupled to each other due to a step therebetween, force are uniformly applied. The flexible cable 300 is provided with a protecting layer corresponding to the protecting layer 400 formed along the outer peripheral surface of the electrode pad 140. That is, the protecting layer corresponding to the protecting layer 400 formed on the electrode pad 140 is formed on the flexible cable 300.

Hereinafter, a description of structures and materials of a base substrate 110, an adhesive layer 200, a flexible cable 300, and a protecting layer 400 of a touch sensor module 1 according to a second embodiment of the invention that are the same as those of the touch sensor module according to the first embodiment of the invention will be omitted, and electrode patterns 120 and 130 of the touch sensor module 1 according to the second embodiment of the invention will be described in detail with reference to FIGS. 7 and 8.

According to an embodiment, the electrode patterns 120 and 130 are formed on one surface of the base substrate 110, and a touch sensor is formed to have single-layer electrode patterns 120 and 130. In a touch sensor module according to a first modified example of the invention, first electrode patterns 120 in an X axis direction and second electrode patterns 130 in a Y axis direction intersecting the first electrode patterns 120 are formed on the base substrate 110 (see FIG. 8). In order to form the first and second electrode patterns 120 and 130 on a single surface to intersect with each other, insulating patterns I are formed on any one of the first and second electrode patterns 120 and 130 at portion at which the first and second electrode patterns 120 and 130 intersect with each other, and the other of the first and second electrode patterns 120 and 130 is electrically connected to each other on the insulating patterns I, such that the first electrode patterns 120 and the second electrode patterns 130 intersecting with each other may implement electrical connection. Although the case in which the first electrode patterns 120 and the second electrode patterns 130 intersect with each other to be perpendicular to each other has been shown, an angle at which the first electrode patterns 120 and the second electrode patterns 130 intersect with each other is not particularly limited. That is, the first electrode patterns 120 and the second electrode patterns 130 intersect with each other at an appropriate angle as long as an X-axis coordinate and a Y-axis coordinate are extracted so that coordinates on a two-dimensional plane are extracted. Since a method of forming the electrode patterns 120 and 130 and a material of the electrode patterns 120 and 130 are the same as those of the electrode patterns according to the first embodiment of the invention described above, a description thereof will be omitted.

Hereinafter, a description of structures and materials of a base substrate 110, electrode patterns 120 and 130, and an adhesive layer 200 of a touch sensor module 1 according to a third embodiment of the invention that are the same as those of the touch sensor module according to the first embodiment of the invention will be omitted, and a protecting layer 400 of the touch sensor module 1 according to the third embodiment of the invention will be described in detail with reference to FIG. 9.

According to an embodiment, the touch sensor module 1 according to the third embodiment of the invention is configured to include a flexible cable having one or more terminal parts, an adhesive layer contacting one surface of the terminal parts to transfer electrical signals, a base substrate including electrode pads formed to correspond to the terminal parts and contacting the other surface of the adhesive layer, and protecting layers formed along edges of the electrode pads.

According to an embodiment, the protecting layers 400 are formed along outer peripheral surfaces of the electrode pads 140. The protecting layers 400 are made of a porous material denser than materials of the electrode pads 140 in order to prevent corrosion of the electrode pads 140. The protecting layers 400 made of the porous material suppress or prevent moisture from permeating into the electrode pads 140.

According to an embodiment, the protecting layers prevent the moisture from permeating into the electrode patterns 120 and 130, the electrode wirings 150 and 160, and the electrode pads 140. Thus, the protecting layers prevent permeation of moisture and sweat at the time of using the touch sensor to prevent an electrical short circuit due to the moisture.

According to an embodiment, the protecting layer is formed along the edge of the electrode pad 140 to be spaced apart from the edge of the electrode pad 140 by a predetermined distance. The predetermined distance should be larger than a diameter D of a conductive ball 210 to be described below. The reason is to prevent the conductive ball 210 from contacting the protecting layer 400 and the electrode pad 140 between the protecting layer 400 and the electrode pad 140 to cause a short circuit. The protecting layers 400 are formed to not electrically interfere with the electrode pads 140.

For example, a relationship between the protecting layers and the electrode pads will be described with reference to FIG. 4. When a distance between the electrode pads is A, a width of a protecting line of the protecting layer is C, a distance between the electrode pad and the protecting layer is B, a distance between the protecting layers is L, and a diameter of the conductive ball is D, the following Equations are satisfied:

1 μm<D<120 μm Equation 1)

B>D Equation 2)

L<A/2 Equation 3)

C+B<A/2 Equation 4)

0<C<A/2−B Equation 5)

Thus, it may be appreciated that the distance between the protecting layer 400 and the electrode pad 140 should be larger than the diameter of the conductive ball and the protecting layers 400 should be formed to not be short-circuited and to enclose the electrode pads 140. In addition, the above mentioned Equations are also applied to the case in which the protecting layers 400 are formed on the terminal parts 320 and 330.

In some cases, as shown in FIG. 6, the protecting layer is formed along a region of a plurality of electrode pads 140. That is, the protecting layer 400 is formed along an outer peripheral surface of the region of the plurality of electrode pads 140.

In this case, the following Equations are satisfied:

1 μm<Diameter (D) of Conductive Ball<120 μm Equation 1)

B>D Equation 2)

Thus, a space between the protecting layer 400 and the electrode pad 140 is larger than a diameter of the conductive ball.

Hereinafter, a description of structures and materials of a base substrate 110, electrode patterns 120 and 130, and an adhesive layer 200 of a touch sensor module 1 according to a fourth embodiment of the invention that are the same as those of the touch sensor module according to the first embodiment of the invention will be omitted, and a protecting layer 400 of the touch sensor module 1 according to the fourth embodiment of the invention will be described in detail with reference to FIG. 10.

According to an embodiment, the touch sensor module 1 according to the fourth embodiment of the invention is configured to include a base substrate including one or more electrode pads transferring electrical signals of electrode patterns to the outside, an adhesive layer contacting one surface of the electrode pads to transfer the electrical signals, a base substrate including terminal parts formed to correspond to the electrode pads and contacting the other surface of the adhesive layer, and protecting layers formed along edges of the terminal parts.

According to an embodiment, the flexible cable 300 is coupled to the electrode pad 140. The flexible cable 300 includes the terminal parts 320 and 330 contacting the adhesive layer 200. The flexible cable 300 is electrically connected to the electrode pad 140 to electrically connect the electrode patterns 120 and 130 and a controlling unit (not shown) to each other. The terminal parts 320 and 330 contact the conductive balls 210, such that they are electrically connected to each other. The protecting layers are formed along outer peripheral surfaces of the terminal parts 320 and 330.

According to an embodiment, the protecting layers 400 are formed along outer peripheral surfaces of the terminal parts 320 and 330. The protecting layers 400 are made of a porous material denser than materials of the terminal part 320 and 330 in order to prevent corrosion of the terminal parts 320 and 330. The protecting layers 400 made of the porous material suppress or prevent moisture from permeating into the terminal parts 320 and 330.

According to an embodiment, the protecting layers prevent the moisture from permeating into the electrode patterns 120 and 130, the electrode wirings 150 and 160, and the terminal parts 320 and 330. Thus, the protecting layers prevent permeation of moisture and sweat at the time of using the touch sensor to prevent an electrical short circuit.

According to an embodiment, the protecting layers are formed along the edges of the terminal parts 320 and 330 to be spaced apart from the edges of the terminal parts 320 and 330 by a predetermined distance. The predetermined distance should be larger than a diameter D of a conductive ball 210 to be described below. The reason is to prevent the conductive ball 210 from contacting the protecting layer 400 and the terminal parts 320 and 330 between the protecting layer 400 and the terminal parts 320 and 330 to cause a short circuit. The protecting layers 400 are formed to not electrically interfere with the terminal parts 320 and 330.

According to the various embodiments of the invention, the protecting layer is formed along the outer peripheral surface of the electrode pad, thereby making it possible to prevent disconnection and a contact defect between the electrode pad and the flexible cable.

In addition, the protecting layer is formed along the outer peripheral surface of the electrode pad to prevent an electrical short circuit between the electrode pad and the flexible cable, thereby making it possible to secure reliability of a product.

Further, the protecting layer is formed along the outer peripheral surface of the electrode pad, thereby making it possible to prevent permeation of moisture into the electrode pad and the flexible cable.

Furthermore, the protecting layer is formed along the outer peripheral surface of the electrode pad, thereby making it possible to prevent or suppress corrosion of the electrode pad and the flexible cable.

Moreover, the protecting layer is formed along the outer peripheral surface of the electrode pad, thereby making it possible to prevent permeation of moisture and sweat at the time of using the touch sensor.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor module, comprising:
a flexible cable having one or more terminal parts;
an adhesive layer contacting one surface of the terminal parts to transfer electrical signals;
a base substrate including electrode pads formed to correspond to the terminal parts and contacting the other surface of the adhesive layer; and
protecting layers formed along edges of the electrode pads.

2. The touch sensor module as set forth in claim 1, wherein the adhesive layer is made of an anisotropic conductive film (ACF) or an anisotropic conductive adhesive (ACA).

3. The touch sensor module as set forth in claim 2, wherein the protecting layer is formed along the edge of the electrode pad to be spaced apart from the edge of the electrode pad by a distance larger than a diameter of a conductive ball made of the ACF or the ACA, thereby preventing a short circuit.

4. The touch sensor module as set forth in claim 1, wherein the protecting layer is made of the same material as that of the electrode pad or is made of a porous material denser than a material of the electrode pad in order to prevent corrosion of the electrode pad.

5. The touch sensor module as set forth in claim 1, wherein the protecting layers are formed along the respective edges of one or more electrode pads.

6. The touch sensor module as set forth in claim 1, wherein the protecting layers are formed in each region of one or more electrode pads.

7. A touch sensor module, comprising:
a base substrate including one or more electrode pads transferring electrical signals of electrode patterns to the outside and first protecting layers formed along outer peripheral surfaces of the electrode pads;
an adhesive layer contacting one surface of the electrode pads to transfer the electrical signals; and
a flexible cable including terminal parts contacting the other surface of the adhesive layer and formed to correspond to the electrode pads and second protecting layers formed along outer peripheral surfaces of the terminal parts.

8. The touch sensor module as set forth in claim 7, wherein the adhesive layer is made of an ACF or an ACA.

9. The touch sensor module as set forth in claim 7, wherein the first protecting layer and the second protecting layer are formed along edges of the electrode pad and the terminal part, respectively, to be spaced apart from the edges of the electrode pad and the terminal part by a distance larger than a diameter of a conductive ball made of an ACF or an ACA, respectively, thereby preventing a short circuit.

10. The touch sensor module as set forth in claim 7, wherein the first protecting layer and the second protecting layer are made of the same materials as those of the electrode pad and the terminal part, respectively, or are made of porous materials denser than materials of the electrode pad and the terminal part, respectively, in order to prevent corrosion of the electrode pad and the terminal part, respectively.

11. The touch sensor module as set forth in claim 7, wherein the first protecting layers and the second protecting layers are formed along the respective edges of one or more electrode pads and the terminal parts, respectively.

12. The touch sensor module as set forth in claim 7, wherein the first protecting layers and the second protecting layers are formed along edges in each region of one or more electrode pads and the terminal parts, respectively.

13. A touch sensor module, comprising:
a base substrate including one or more electrode pads transferring electrical signals of electrode patterns to the outside;
an adhesive layer contacting one surface of the electrode pads to transfer the electrical signals;
a flexible cable including terminal parts formed to correspond to the electrode pads and contacting the other surface of the adhesive layer; and
protecting layers formed along edges of the terminal parts.

14. The touch sensor module as set forth in claim 13, wherein the adhesive layer is made of an ACF or an ACA.

15. The touch sensor module as set forth in claim 14, wherein the protecting layer is formed along the edge of the electrode pad to be spaced apart from the edge of the electrode pad by a distance larger than a diameter of a conductive ball made of the ACF or the ACA, thereby preventing a short circuit.

16. The touch sensor module as set forth in claim 13, wherein the protecting layer is made of the same material as that of the terminal part or is made of a porous material denser than a material of the terminal part in order to prevent corrosion of the terminal part.

17. The touch sensor module as set forth in claim 13, wherein the protecting layers are formed along the respective edges of one or more terminal parts.

18. The touch sensor module as set forth in claim 13, wherein the protecting layers are formed in each region of one or more terminal parts.
